(19) United States
(12) Patent Application Publication
(10) Pub. No.: US 2009/0072430 A1
(43) Pub. Date: Mar. 19, 2009

(54) Belt and systems for continuous vacuum forming

(76) Inventor: Kenneth Bosler, Holland, PA (US)

Correspondence Address: MATHEWS, SHEPHERD, MCKAY, & BRUNEAU, P.A., 29 THANET ROAD, SUITE 201, PRINCETON, NJ, 08540, US

(21) Appl. No.: 11/901,640

(22) Filed: Sep. 17, 2007

(51) Int. Cl. B29C 35/02; B28B 3/20

(52) U.S. Cl. 264/176.1; 425/405.1

(57) ABSTRACT

The present invention relates to a belt used in continuous vacuum forming. The belt comprises a heat absorbing material. In one embodiment, the heat absorbing material comprises graphite.

### BACKGROUND OF THE INVENTION

1. Field of the Invention

The present invention relates to a belt and systems for continuous vacuum forming having one or more belts in which the belt includes a heat absorbing material.

2. Description of Related Art

Continuous vacuum forming processes are known for shaping an extruded plastic sheet. U.S. Pat. No. 5,314,325 describes an apparatus for continuous vacuum forming in which hot plasticized material is drawn in contact with a flexibly resilient belt. The flexibly resilient belt includes a pattern form means thereon which is flexibly resilient. The resilience of the pattern form means allows it to pass around cylindrical rollers and be flexed while still retaining form.

U.S. Pat. No. 6,641,384 describes an apparatus for continuous vacuum forming of a hot plasticized material between a pair of rotating flexible belts in which one belt includes a plurality of teeth, which are received in a plurality of indentations of the other belt. Each of the belts includes a mold, which forms a channel when the belts are adjacent to one another. A vacuum is applied to at least one of the flexible belts for drawing material received in the channel of the belt and for alignment of the belts. Each belt can include a plurality of apertures, which are in fluid flow communication with a plurality of perforations of a flat support belt positioned over a vacuum manifold. The belts can be formed of a rubber material, or rubberized material, such as silicone rubber.

It has been found that in the above-described systems, heat is transferred from the hot plasticized material to the flexible belts. The absorption of heat in the belts can result in cracking of the belts.

It is desirable to provide an improved belt for operating a continuous vacuum forming system at high temperatures.

### SUMMARY OF THE INVENTION

The present invention relates to a belt used in continuous vacuum forming. The belt comprises a heat absorbing material. In one embodiment, the heat absorbing material comprises graphite.

In one embodiment, a system for continuous vacuum forming a material includes the belt having a heat absorbing material. The belt is continuously rotatable with a flat support belt. The rotatable belt includes apertures therein. The support belt includes perforations therein. The flat support belt is fitted over rotatable rollers and the rotatable belt is fitted over the support belt. The rotatable belt receives the material to be vacuum formed. The belts are rotated by rotatable rollers over a vacuum means. The vacuum means provide a vacuum with the apertures in the rotatable belt and the perforations in the support belt for drawing the material against the rotatable belt.

In another embodiment, the system for continuous vacuum forming includes a pair of the belts having a heat absorbing material. The belts can be rotated using a plurality of teeth in one belt, which are received in a plurality of indentations of the other belt. A vacuum is applied to at least one of the belts for drawing material received between the belts and alignment of the belts. Preferably, a vacuum can be applied to both of the belts for improved alignment. Each belt can include a plurality of apertures, which are in fluid flow communication with a plurality of perforations of a flat support belt positioned over a vacuum manifold.

The invention will be more fully described by reference to the following drawings.

### BRIEF DESCRIPTION OF THE DRAWINGS

FIG. 1 is a schematic diagram of a system for continuous vacuum forming in accordance with the teachings of the present invention.

FIG. 2 is a top perspective view of the rotatable belt and support belt of the present invention used in the system shown in FIG. 1.

FIG. 3 is a schematic diagram of a dual belt system for continuous vacuum forming including dual rotatable belts in accordance with the teachings of the present invention.

FIG. 4 is a front and side perspective view of an extruded material being received in a dual belt continuous vacuum forming system.

FIG. 5 is a top perspective view of the rotatable belt and support belt of the present invention used in the system shown in FIG. 4.

### DETAILED DESCRIPTION

Reference will now be made in greater detail to a preferred embodiment of the invention, an example of which is illustrated in the accompanying drawings. Wherever possible, the same reference numerals will be used throughout the drawings and the description to refer to the same or like parts.

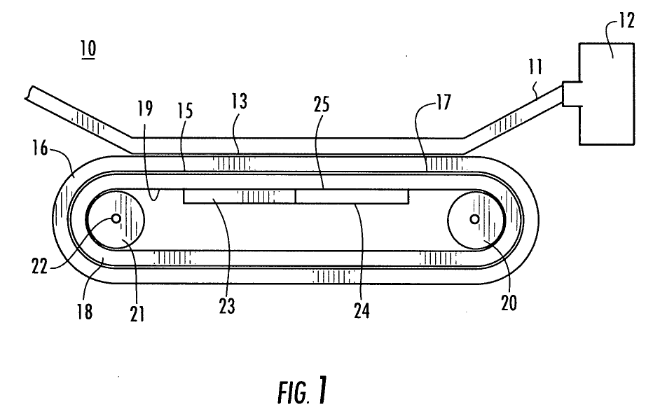

FIG. 1 is a schematic diagram of a system for continuous vacuum forming 10 in accordance with the teaching of the present invention. Extruded material 11 exits extruder 12 and is received on top surface 13 of rotatable belt 16. Rotatable belt 16 is an endless belt. Extruded material 11 can be any thermoplastic material. For example, extruded material 11 can be formed of polyvinylchloride (PVC), polystyrene, acrylonitrile-butadiene-styrene (ABS), nylon, ethylene-vinyl acetate (EVA), polycarbonate, polyethylene, polypropylene, polyethylene terepathalate, thermoplastic olefins, acrylonitrile-styrene-acrylic (ASA), and alloys, blends or coextrusions of these resins. Suitable thermoplastic materials can include cellulose fibers, reinforcement elements, colorants, foamants, fillers and the like, which are compatible with the thermoplastic material. A preferred extruded material 11 is expandable (PVC) with cellulose reinforcement fibers. Extruded material 11 can have an elevated temperature in the range of about 250° F. to about 400° F.

Support belt 18 is positioned underneath rotatable belt 16. Upper surface 17 of support belt 18 contacts bottom surface 15 of rotatable belt 16. Rotatable belt 16 and support belt 18 extend around rollers 20 and 21. Rollers 20 and 21 are driven by driving means 22 to make rolling contact with bottom surface 19 of support belt 18. Vacuum means 23 applies a vacuum through vacuum manifold 24 to an area 25 between rollers 20 and 21.

Preferably, rotatable belt 16 is formed of a rubber material or a rubberized material and including an amount of a heat absorbing material. An example suitable heat absorbing material is graphite. The rubberized material can be silicon rubber. An example amount of the heat absorbing material used in rotatable belt 16 can be in the range of about 2% to about 10% by weight of the rubber or rubberized material. It will be appreciated that rotatable belt 16 can be used to replace the respective flexible belt described in U.S. Pat. No. 5,906,840, the details of which are herein incorporated by reference into this application.

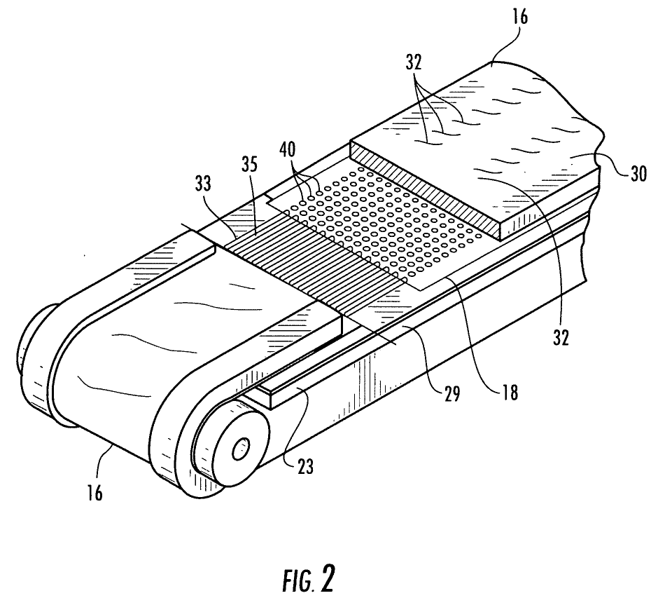

Pattern 30 can be formed in rotatable belt 16, as shown in FIG. 2. For example, pattern 30 can resemble a grained texture surface with raised and depressed surface areas such as is used in vinyl siding applications. Plurality of apertures 32 can be formed in rotatable belt 16. During vacuum forming, pattern 30 forms a grooved surface in extruded material 11 to form a grained product which is particularly advantageous in vinyl siding products. Apertures 32 are preferably placed at inconspicuous locations in pattern 30 such that they are positioned in raised surface areas which are not observable on the formed plasticized product.

Support belt 18 is preferably formed of a flat perforated metal material. For example, metal materials useful for forming support belt 18 include stainless steel, aluminum and nickel. A plurality of perforations 40 can be formed in support belt 18. For example, perforations 40 can have a diameter of about 1/32 of an inch to about 1/16 of an inch and can have a spacing between each perforation of about ¼ inch to about ½ inch. Apertures 32 are in fluid flow communication with perforations 40 to facilitate drawing of extruded material 11 onto top surface 13 of rotatable belt 16 by vacuum means 23. Vacuum means 23 can include grooved sheet 33 attached to vacuum manifold 24. Vacuum means 23 forms a vacuum along grooves 35 of grooved sheet 33.

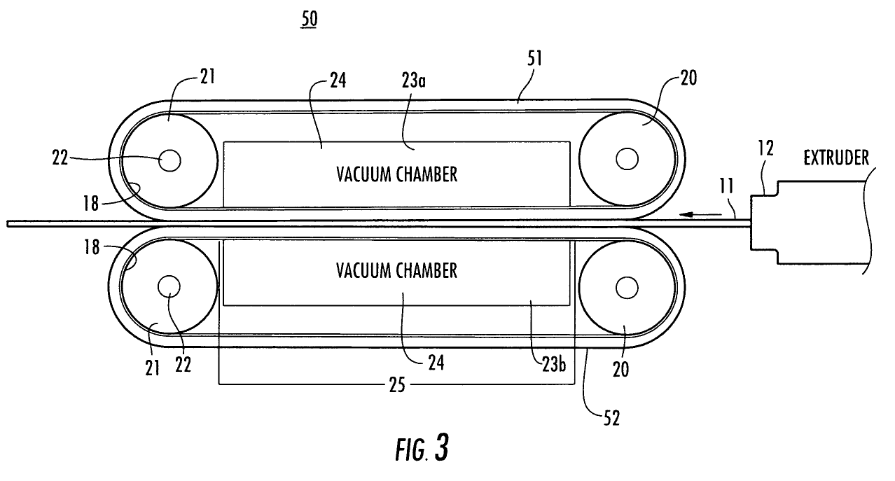

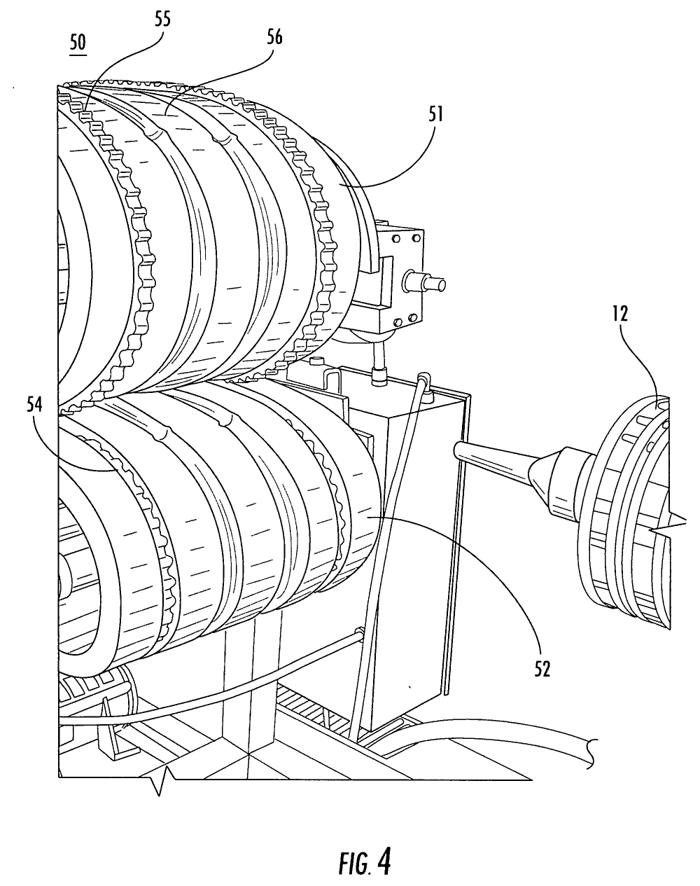

In an alternate embodiment, extruded material 11 is received between upper belt 51 and lower belt 52 of dual belt continuous vacuum forming system 50, as shown in FIG. 3. Upper belt 51 and lower belt 52 rotate during continuous vacuum forming using rollers 20 and 21. Lower belt 52 includes a plurality of indentations 54 for receiving corresponding teeth 55 extending from outer surface 56 of upper belt 51, as shown in FIG. 4. Support belts 18 are positioned adjacent upper belt 51 and lower belt 52. Upper belt 51, lower belt 52 and support belts 18 are rotated by rollers 20 and 21, as shown in FIG. 3. Rotation of upper belt 51 rotates lower belt 52 by continuous pulling of teeth 55. Upper belt 51 and lower belt 52 are endless belts. One or more of vacuum means 23a, 23b applies a vacuum through vacuum manifold 24 to an area 25 between rollers 20 and 21.

Upper belt 51 and lower belt 52 are flexible patterned belts for applying a pattern to extruded shaped material 11. For example, the pattern can be a textured grain pattern. Preferably, upper belt 51 and lower belt 52 have a thickness of about 1 to about 2 inches to provide flexibility without cracking of the belts. Preferably, upper belt 51 and lower belt 52 are formed of a rubber of rubberized material including an amount of a heat absorbing material. A suitable example heat absorbing material is graphite. The rubberized material can be silicon rubber. An example amount of the heat absorbing material used in rotatable belt 16 can be in the range of about 2% to about 10% by weight of the rubber or rubberized material.

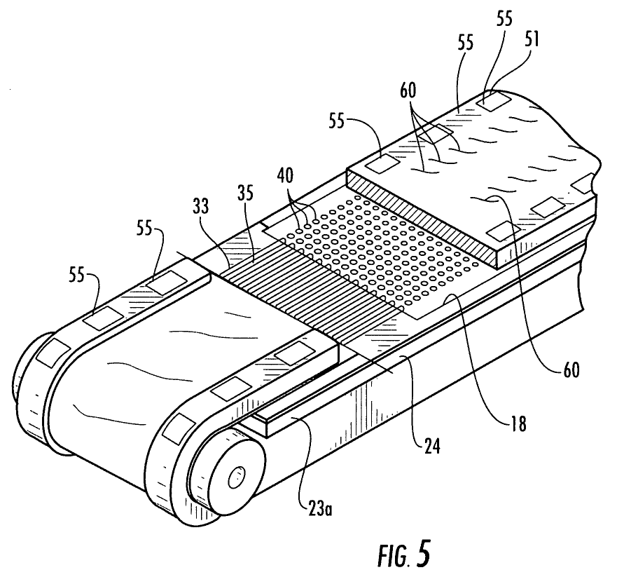

Referring to FIG. 5, a plurality of apertures 60 can be formed in upper belt 51 and lower belt 52 (not shown). Apertures 60 are in fluid flow communication with perforations 40 of support belt 18 to facilitate drawing of extruded shaped material 11 by vacuum manifold 23. It will be appreciated that upper belt 51 and lower belt 52 can be used to replace the upper and lower belts described in U.S. Pat. No. 6,661,384, the details of which are hereby incorporated by reference into this application.

Belt 16 or upper belt 51 and lower belt 52 allows respective continuous vacuum forming system 10 or dual belt continuous vacuum forming system 50 to operate at elevated temperatures. For example, continuous vacuum forming system 10 or dual belt continuous vacuum forming system 50 can operate at temperatures in the range of 140° F. to 400° F. without cracking of belt 16.

It is to be understood that the above-described embodiments are illustrative of only a few of the many possible specific embodiments, which can represent applications of the principles of the invention. Numerous and varied other arrangements can be readily devised in accordance with these principles by those skilled in the art without departing from the spirit and scope of the invention.

What is claimed is:

1. In an apparatus for continuous vacuum forming a belt comprising a heat absorbing material.

2. The apparatus of claim 1 wherein said belt further comprises a rubberized material wherein said heat absorbing material is present in a range of about 2% to about 10% of said rubberized material.

3. The apparatus of claim 1 wherein said heat absorbing material is graphite.

4. The apparatus of claim 1 wherein said belt is adapted to receive an extruded material having an elevated temperature in the range of about 250° F. to about 400° F.

5. An apparatus for continuous vacuum forming an extruded material comprising:
a pair of spaced apart rotatable rollers;
a support belt being fitted over said pair of rotatable rollers and being rotated by said rollers, said support belt being flat and having perforations spaced along the length and width thereof; and
a rotatable belt being fitted over said support belt and being rotated with said support belt, said rotatable belt comprising a heat absorbing material and adapted for receiving said extruded material; and
vacuum means positioned adjacent said support belt,
wherein said vacuum means is in fluid flow communication with said perforations of said support belt and said apertures of said rotatable belt for drawing the extruded material onto said rotatable belt.

6. The system of claim 5 wherein said rotatable belt is a flexible patterned belt.

7. The system of claim 5 wherein said rotatable belt further comprises a rubberized material wherein said heat absorbing material is present in a range of about 2% to about 10% of said rubberized material.

8. The system of claim 5 wherein said heat absorbing material is graphite.

9. The system of claim 5 wherein said extruded material has an elevated temperature in the range of about 250° F. to about 400° F.

10. A dual belt continuous vacuum forming system comprising:
an upper belt being fitted over a first support belt rotating on a first pair of rollers, said first support belt being flat and having perforations spaced along the length and width thereof, said upper belt having apertures spaced along the length and width thereof;
a lower belt being fitted over a second support belt rotating on a second pair of rollers, said second support belt being flat and having perforations spaced along the length and width thereof, said second lower belt having apertures spaced along the length and width thereof; and
one or more vacuum regions being positioned adjacent said first support belt and said second support belt, said vacuum regions are in fluid flow communication with said perforations of said first support belt and said second said support belt and said apertures in said upper belt and said lower belt for drawing the material onto said lower belt, said upper belt and said lower belt comprising a heat absorbing material.

11. The system of claim 10 further comprising:
a plurality of teeth being formed in said upper belt; and
a plurality of indentations being formed in said lower belt, each of said teeth being received in one of said indentations, in which rotation of said upper belt rotates said lower belt by continuous pulling of said teeth and said plurality of teeth received in respective said plurality of indentations provides alignment of said upper belt and said lower belt.

12. The system of claim 10 wherein said one or more vacuum regions comprise vacuum means for supplying a vacuum to a vacuum manifold.

13. The system of claim 10 wherein said upper belt and said lower belt are flexible patterned belts.

14. The system of claim 10 wherein said upper belt and said lower belt further comprise a rubberized material wherein said heat absorbing material is present in a range of about 2% to about 10% of said rubberized material.

15. The system of claim 10 wherein said heat absorbing material is graphite.

16. A method for vacuum forming comprising the steps of:
extruding a material onto a rotatable belt, said rotatable belt comprising a heat absorbing material; and
vacuum forming the extruded material to said rotatable belt.

17. The method of claim 16 wherein said step of vacuum forming applies a textured pattern to the extruded material.

18. The method of claim 16 wherein the extruded material has an elevated temperature in the range of about 250° F. to about 400° F.

19. A belt for continuous vacuum forming comprising a rubberized material and a heat absorbing material.

20. The belt of claim 19 wherein said heat absorbing material is present in a range of about 2% to about 10% of said rubberized material.

21. The belt of claim 19 wherein said heat absorbing material is graphite.
